(19) United States
(12) Patent Application Publication
(10) Pub. No.: US 2013/0070921 A1
(43) Pub. Date: Mar. 21, 2013

(54) GATEWAY AUTOMATIC DIALER SUPPORT

(71) Applicants: Thomas Patrick Newberry, Westfield, IN (US); Michael Evan Crabb, Carmel, IN (US); Stephen Jon Vincent, Atlanta, GA (US)

(72) Inventors: Thomas Patrick Newberry, Westfield, IN (US); Michael Evan Crabb, Carmel, IN (US); Stephen Jon Vincent, Atlanta, GA (US)

(73) Assignee: THOMSON LICENSING, Issy de Moulineaux (FR)

(21) Appl. No.: 13/639,181

(22) PCT Filed: Apr. 12, 2011
(86) PCT No.: PCT/US11/00668

§ 371 Date: Oct. 3, 2012

Related U.S. Application Data
(60) Provisional application No. 61/324,881, filed on Apr. 16, 2010.

(51) Int. Cl. H04M 1/274

(52) U.S. Cl. 379/355.01

(57) ABSTRACT

A method functions to resolve conflicts between wireless digital telephony and traditional analog telephony when an automatic telephone number dialer is concurrently used in a gateway. The method acts to prioritize telephone calls that operate using one telephone line when a single analog telephone line interfaces with an automatic telephone dialer and an analog telephone set in a system that also operates with a wireless digital telephone interface. The method includes detecting if an active call is present and determines if the telephone number being dialed is of higher priority than the active call. The highest priority call is placed or preserved according to the highest priority regardless of the source of the call in the system.

### CROSS REFERENCE TO RELATED APPLICATION

This application claims priority to U.S. Provisional Application No. 61/324,881 entitled “Cable Gateway Home Alarm Support”, filed on 16 Apr. 2010, which is hereby incorporated by reference in its entirety.

### FIELD

The present invention relates to telecommunications, and in particular, to the accommodation of an automatic dialer in connection with a gateway.

### BACKGROUND

Automatic dialers can be connected to a single telephone line such that the line can be shared with typical analog telephone lines. FIG. 1 depicts a system 100 with a shared telephone line connection between an automatic dialer 102 and local analog telephone set 103. The telephone network 101 provides an analog telephone interface to a junction box 104 that allows the local analog telephone to use the single telephone line provided by the telephone network 101. Typically, in the United States, such junction boxes are known as RJ-31X connection boxes and are typically used in connection with the analog telephone system also known as the plain old telephone system (POTS). In a US conventional system, the interface to the local analog telephone set can be a RJ-11 standard jack interface.

Typically, junction boxes are installed in a building, such as a home or business, such that calls may be placed by the local analog telephone 103. In one equivalent circuit, junction box 104 contains no active switches, but switch SW1 in the automatic dialer 102 allows local analog telephone calls to be placed when in position A. When the automatic dialer acts to seize the telephone line, the automatic dialer can change SW1 to position B. This action interrupts any call in process with the local analog telephone 103 and allows the automatic dialer to place a call. Junction boxes, with functions such as the RJ-31X, also allow the local analog telephone to work when no automatic dialer is attached. The instrumentality for this function is not shown in FIG. 1 for simplicity.

Automatic dialers may function as a part of a security system for a home or business office. In this instance, the automatic dialer may place a call to police, a fire station, or an ambulance as needed. In an alternative setting, the automatic dialer may be part of a business office where the automatic dialer automatically places a call for any business-relevant event such as a fax call to replace inventory, a credit card check, or any other automatic business call.

One clear disadvantage of such a system is that when the automatic dialer 102 seizes the single telephone line, any active call on the analog telephone set 103 is prematurely interrupted. In this system, it can be appreciated by one of skill in the art that if the active call is considered a high priority call, then the automatic dialer can interrupt the high priority active call to connect a lower priority automatically dialed call. This forced and non-prioritized interruption of an active call can be disruptive. With the advent of digital telephony, the inclusion of automatic analog dialers can present an unintended cessation of high priority active call in favor of an automatic dialer placed call.

### BRIEF SUMMARY

The present invention functions to isolate or resolve conflicts between wireless digital telephony and traditional analog telephony when an automatic telephone number dialer is concurrently used. Example embodiments provide a solution to the problem of high priority calls being terminated in favor of lower priority automatic dialer placed calls.

In one embodiment, an apparatus for prioritizing telephone calls that operates using one telephone line includes an analog telephone line interface connecting to an automatic telephone dialer and an analog telephone, a wireless digital telephone interface, and a network interface. The apparatus accommodates a call placed from the automatic dialer be placed subject to a telephone number priority evaluation. If the evaluation determines that the automatic dialer telephone number is lower than the active call, then the automatic dialer call placement is ignored. An interruption of an active call is allowed only when a higher priority telephone call is to be made by the automatic dialer as compared to the active call that is present on either the analog interface or the wireless digital telephone interface.

In one embodiment, a method is performed by a gateway connected to an automatic dialer. The method includes detecting if an active call is present, and detecting if a second phone number is dialed. If the second telephone number has a higher priority than the active first telephone phone number, then the active call is interrupted and the second telephone number call is placed. Alternately, if the second telephone number has a lower priority than the first telephone number, then the detected second telephone number call is ignored.

Additional features and advantages of the invention will be made apparent from the following description of illustrative embodiments which proceeds with reference to the accompanying figures.

### BRIEF DESCRIPTION OF THE DRAWINGS

FIG. 1 illustrates a prior art example technique to add a automatic dialer to a single local analog telephone;

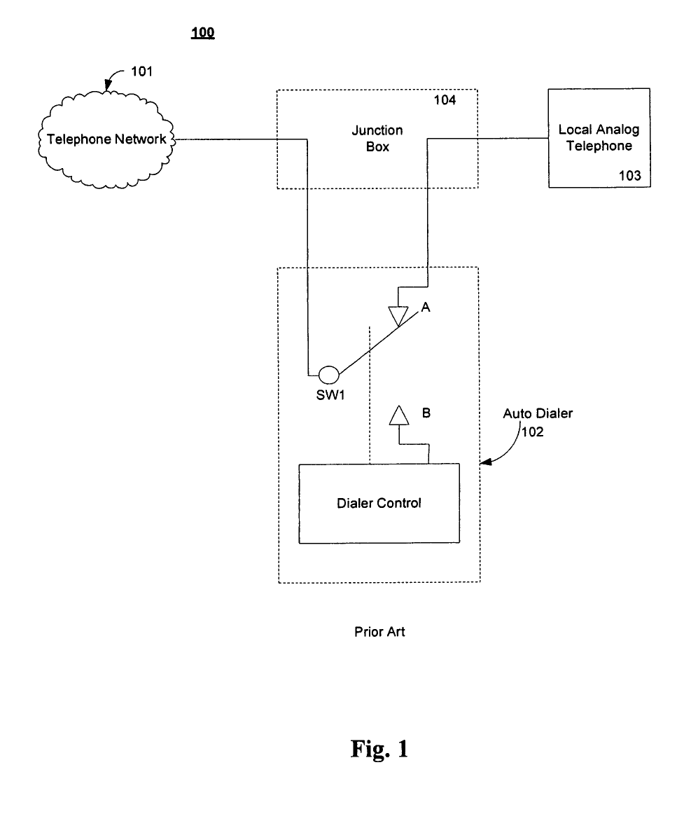

FIG. 2 illustrates a gateway supporting an analog telephone and multiple wireless phones;

FIG. 3 illustrates an example block diagram of a gateway according to aspects of the invention;

FIG. 4 illustrates an example diagram of a gateway system interfacing to an automatic dialer according to an aspect of the invention; and

FIG. 5 illustrates an example flow diagram of a method according to aspects of the invention.

### DETAILED DISCUSSION OF THE EMBODIMENTS

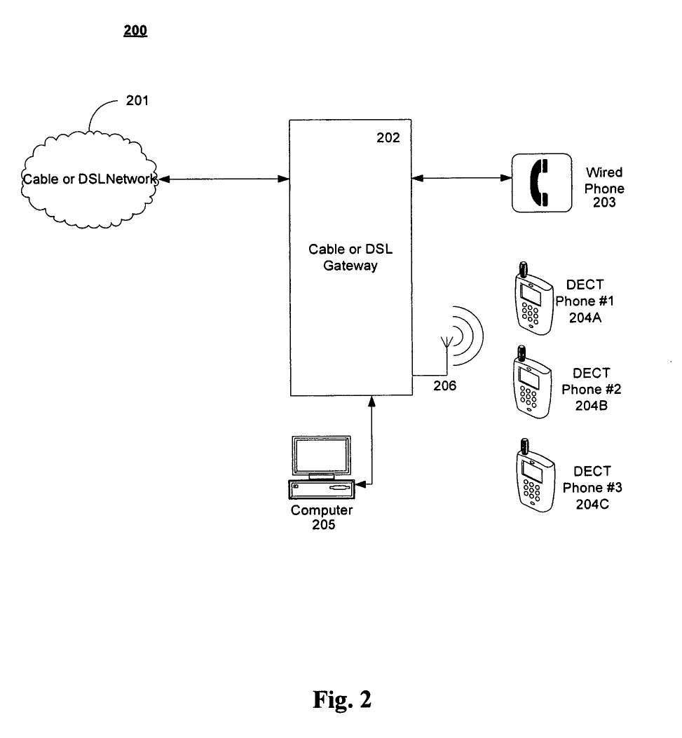

A gateway is a device that acts to interface a network that can transport data packets, such as packets in an IP network, to other forms of conventional devices such as analog telephones. Typical gateways include cable gateways and Digital Subscriber Line (DSL) gateways. Cable gateways include cable modems and DSL gateways include DSL modems to interface with their respective protocols. FIG. 2 depicts an example cable or DSL gateway system 200 that acts to interface a packet data cable system or DSL network 201 to a wired analog telephone set 203. Here, the interface to the wired telephone can be a standard RJ-11 analog telephone interface. In addition, a cable or DSL gateway 202 can also act to provide a radio frequency (RF) interface to multiple wireless handsets 204A, 204B, and 204C. FIG. 2 depicts digital enhanced cordless telecommunications (DECT) terminals as the wireless handsets. DECT handsets generally operate at 1.7 GHZ to 1.9 GHz or other frequency and by wireless packet transmissions via an antenna 206 on the cable or DSL gateway 202. The DECT wireless handset is provided in FIG. 2 only as a reference example. Many different formats of wireless digital telephony may be used. In one embodiment, the Wi-Fi-friendly worldwide digital cordless telecommunications (WDCT) handsets operate typically at 2.4 GHz or other frequency. One of skill in the art will recognize that the wireless interface of FIG. 2 using antenna 206 can accommodate DECT handsets, WDCT handsets, or other digital wireless format handsets. The current example of DECT handsets will be used as an example for simplicity, but the invention is not limited to DECT use.

In FIG. 2, the case of either the wired phone 203 or the DECT handsets 204A-C, the cable or DSL gateway provides voice over interne protocol (VoIP) services between the handsets and telephone destinations connected via the cable or DSL network 201. The cable or DSL network can provide connectivity between the cable or DSL gateway 202 and another cable or DSL gateway or to service providers to add extensive connectivity to a standard analog telephone system, such as the POTS described above. Cable or DSL gateway 202 also provides connectivity to a local computer 205 either via a wired connection such as is shown in FIG. 2 or via a wireless connection (not shown). Thus, example interfaces for computer 205 include Ethernet and IEE802.11.

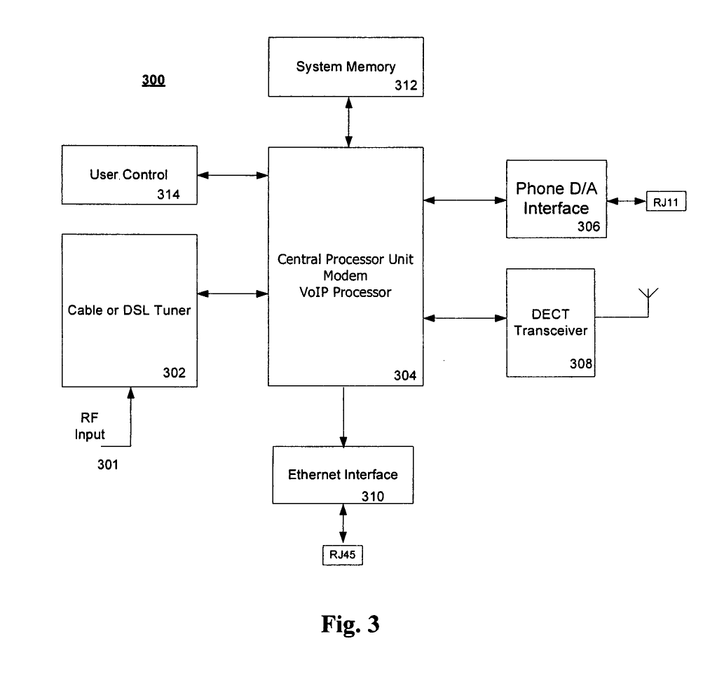

FIG. 3 depicts a block diagram 300 of a cable or DSL gateway, such as item 202 in FIG. 2. In one embodiment of FIG. 3, the RF cable or DSL interface 301 is received and by a cable or DSL tuner 302 which performs RF modulation and demodulation functions. The central processor, modem, and voice over internet protocol (VoIP) unit 304 accepts the demodulated cable or DSL signals and further digitally processes the received cable or DSL signals to provide voice data for the cable or DSL gateway telephony interfaces. System Ram 312 supports the central processor and VoIP functions as storage for program and data information. Processed digital data is available for transfer between the Ethernet Interface 310, which can support a typical RJ-45 or other standard interface connector to a connected external local computer. Processed digital data from central processor, modem, and VoIP processor 304 is available for digital to analog conversion in interface 306 to an analog telephone handset. Typically, this is provided via an RJ-11 standard interface, but other interface standards may be used. Processed digital data is also available for exchange with the DECT transceiver 308 which can support multiple wireless DECT handsets simultaneously.

In the configuration of FIG. 2, multiple independent telephone lines can be made available via the cable or DSL network in conjunction with the multiple DECT handsets and local analog telephone line. However, multiple telephone lines can be expensive for a user of the system 200. Accordingly, a cable or DSL gateway as described above can be used to connect DECT handsets and a local analog telephone using only one subscriber telephone line. In addition, if the system 200 also includes an automatic dialer, such as in a security system, then active calls placed via the DECT handsets and the analog telephone may be adversely affected.

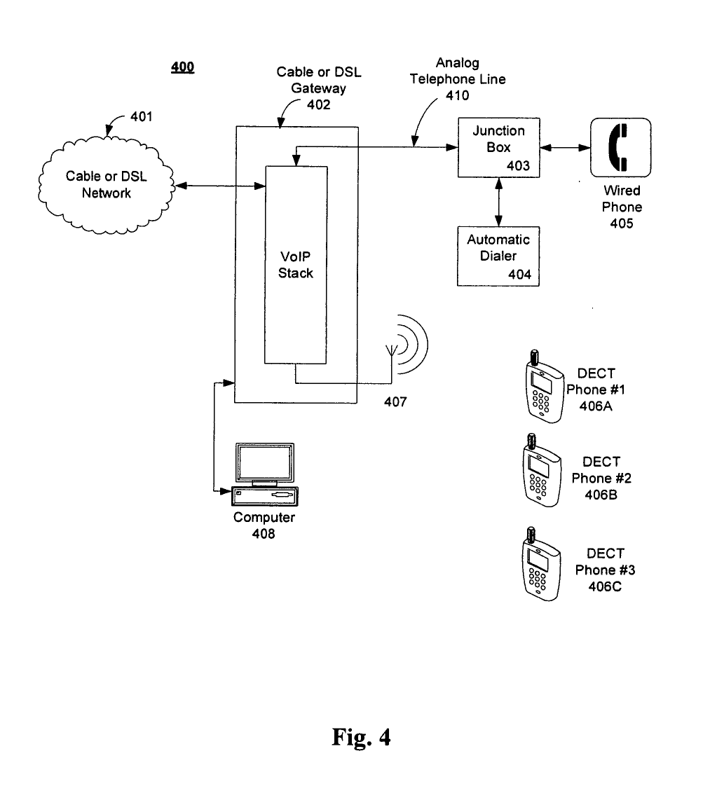

FIG. 4 depicts a cable or DSL gateway system 400 which includes an automatic dialer and one subscriber telephone line. A cable or DSL network 401 provides packet data type interface that communicates with the cable or DSL gateway 402. In this embodiment, a junction box 403, such as a RJ-3 IX type or other type, is used to provide connectivity to a single analog telephone line 410 to be used by either an automatic dialer 404 or a wired analog telephone 405. DECT handsets, or other types of wireless handsets, can share the one subscriber telephone line simultaneously along with the wired telephone handset 405. The wireless handsets are interfaced via antenna 407 to the cable or DSL gateway 402. In operation, the cable or DSL gateway allows any or all of the DECT phones to be active on the same subscriber telephone line. In this configuration, one effect is that the automatic dialer 404 can terminate active calls placed via any of either the analog telephone 405 or the DECT handsets. This effect can have the adverse consequence of terminating a critically important active call. In one possible scenario, an active call may be directed to a police authority to solicit help or get instruction. If the auto dialer goes off-hook, then the junction box 403 allows the one telephone line to be interrupted. As a result, the active call, for example, to the police authority, is prematurely terminated in favor of the automatic dialer 404. This adverse result is averted by use of aspects of the present invention. If a cable or DSL gateway is used along with an automatic dialer, it is desired that the automatic dialer can interrupt an active call in progress, but not if that active call is a higher priority than that of the call to be placed by the automatic dialer.

Cable or DSL gateway 402 includes a central processing unit that can be programmed to recognize hierarchies corresponding to priorities in telephone numbers. In one embodiment, a list of phone numbers may be entered into the cable or DSL gateway 402. The cable or DSL gateway 402 can then allow automatic dialer 404 to interrupt an active call only if the active call is a lower priority than the phone number to be dialed by the automatic dialer. If the active call phone number has a higher priority than the phone number to be connected via the automatic dialer, then the automatic dialer call would be ignored. Thus, an active call on the analog telephone or on the wireless digital telephone interfaces will be interrupted when the automatic dialer places a call on the analog telephone line interface, except where a higher priority telephone call is already active on either the analog interface or the wireless digital telephone interface.

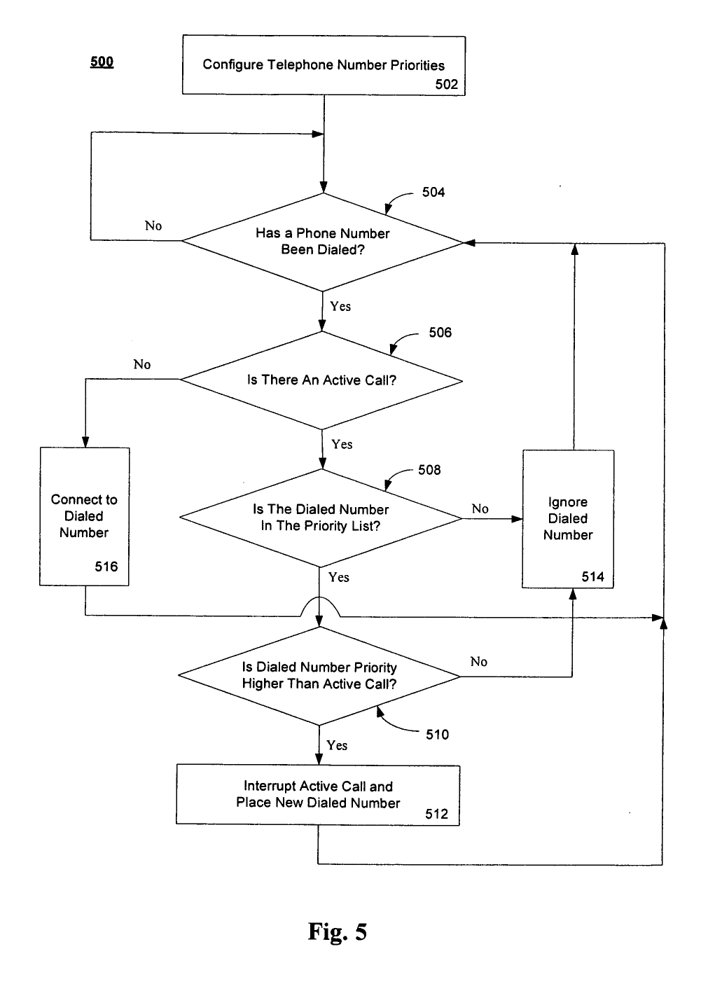

FIG. 5 is a flow diagram according to aspects of the invention. Initially, the gateway can be configured, as in step 502, with a set of telephone number priorities. The configuration or setup of the list of telephone numbers and their respective priorities may be performed in multiple manners.

In one embodiment, the loading or setting of priorities for selected telephone number may be accomplished via the interface to computer 408 in FIG. 4. Although a wired interface, such as an Ethernet interface, is shown in FIG. 4, any interface may be used including a wireless interface. In operation, a user interface, such as a graphical user interface (GUI) may be provided by addressing the gateway 402 via a fixed local web address in the gateway. The gateway can respond to the browser in the computer 408 by providing a web-page that includes multiple menus for set-up of the gateway. One or more of these configuration set-up menu pages accommodates entry or submission of a prioritized list of telephone numbers. In one embodiment, higher priority telephone numbers, such as police, fire, ambulance, and other emergency numbers can be designated as having greater priority than other telephone numbers that are listed. Lower priority telephone numbers may include fax telephone numbers to business suppliers or credit check phone numbers. In one embodiment, if a phone number is not listed, then that telephone number has the lowest priority. Thus only telephone numbers listed have designated priorities. Telephone numbers that are not provided to the gateway have no priority over any other telephone number.

Another technique to enter telephone numbers and their respective priorities is to allow manual entry of telephone numbers via either of the analog telephone 405 or any one of the wireless handsets. In this mode of entry, the gateway can accept dual tone multi-frequency (DTMF) entries as telephone numbers and priorities. Such an entry could also be accommodated via the use of keys and/or prompts from the gateway to the user via physical or soft interfaces on the gateway cover panels.

Another technique to configure the telephone priority list is to use a simple network management protocol (SNMP) remote call. This remote interface allows a user or system administrator to configure the gateway telephone number priorities via a remote interface, such as via the cable or DSL network interface.

Returning to FIG. 5, once the configuration of telephone numbers and priorities is accomplished, the gateway system can be placed into service. At this point steps 504 through 516 serve as the basis for functionality of the gateway in providing telephone line management. At step 504, the gateway can detect if a telephone number has been dialed by monitoring if any number has been dialed. Generally, a phone number dialing can occur if a handset is operated (becomes off-hook) and a phone number is dialed regardless if an active call is in progress or not. Thus, if the analog telephone dials a telephone number, or if a wireless handset dials a telephone number, or if the automatic dialer dials a telephone number, then step 504 will detect the dialed telephone number and move to step 506.

At step 506, a determination is made if an active call is in progress. If there is no active call in progress, then step 506 moves to step 516 and the dialed number is connected. After connection, the method 500 returns to step 504 to wait for the detection of another number that is dialed. If there is an active call present at step 506, then the method moves to step 508 where the dialed number is compared against the priority list of telephone numbers. At step 508, if the dialed telephone number is not on the telephone number priority list, then step 508 moves to step 514 and the dialed number is ignored. This action occurs because the the number dialed has no priority with respect to the active call. Thus, the active call must have a higher priority. The method 500 then returns to step 504 to await another dialed number. However, if the dialed number is on the priority list, then step 508 moves to step 510 where priorities are compared.

At step 510 if the dialed number has a lower priority compared to the active call telephone number, then step 510 moves to step 514 and the dialed number is ignored. The method 500 then returns to step 504 and awaits entry of another dialed number. However, if the dialed number has a priority higher than the active call telephone number, then step 510 moves to step 512. At step 512, the active call is interrupted and a new call is placed using the newly dialed number. After the newly dialed, high priority telephone call placed, the method 500 returns to step 504 and awaits another dialed telephone number.

The implementations described herein may be implemented in, for example, a method or process, an apparatus, or a combination of hardware and software. Even if only discussed in the context of a single form of implementation (for example, discussed only as a method), the implementation of features discussed may also be implemented in other forms (for example, a hardware apparatus, hardware and software apparatus, or a computer-readable media). An apparatus may be implemented in, for example, appropriate hardware, software, and firmware. The methods may be implemented in, for example, an apparatus such as, for example, a processor, which refers to any processing device, including, for example, a computer, a microprocessor, an integrated circuit, or a programmable logic device. Processing devices also include communication devices, such as, for example, computers, cell phones, portable/personal digital assistants (“PDAs”), and other devices that facilitate communication of information between end-users.

Additionally, the methods may be implemented by instructions being performed by a processor, and such instructions may be stored on a processor or computer-readable media such as, for example, an integrated circuit, a software carrier or other storage device such as, for example, a hard disk, a compact diskette, a random access memory (“RAM”), a read-only memory (“ROM”) or any other magnetic, optical, or solid state media. The instructions may form an application program tangibly embodied on a computer-readable medium such as any of the media listed above. As should be clear, a processor may include, as part of the processor unit, a computer-readable media having, for example, instructions for carrying out a process. The instructions, corresponding to the method of the present invention, when executed, can transform a general purpose computer into a specific machine that performs the methods of the present invention.

1. An apparatus for prioritizing telephone calls, the apparatus comprising:
an analog telephone line interface connecting to an automatic telephone dialer and an analog telephone;
a wireless digital telephone interface for a wireless digital telephone;
a network interface that accommodates a telephone call placed from the analog telephone or the wireless digital telephone;
wherein an active call using the analog telephone or the wireless digital telephone is interrupted when the automatic dialer places a telephone call on the analog telephone line interface, except where a higher priority telephone call is already active.

2. The apparatus of claim 1, wherein the analog telephone line interface has connectivity to the automatic telephone dialer and the analog telephone via a junction box.

3. The apparatus of claim 1, wherein the apparatus is a gateway, the network interface is connects to a packetized data network, and the wireless digital telephone interface connects to one or more of a digital enhanced cordless telecommunications (DECT) handset or a worldwide digital cordless telecommunications (WDCT) handset.

4. The apparatus of claim 1, wherein the apparatus comprises a cable or DSL gateway connecting to a packetized data network.

5. The apparatus of claim 1, wherein the network interface is a cable or DSL network interface.

6. The apparatus of claim 1, wherein the automatic telephone dialer comprises one of a security system incorporating the automatic telephone dialer or a fax device incorporating the automatic telephone dialer.

7. The apparatus of claim 1, wherein the apparatus is configured via one or more of a local computer interface, a remote communication interface, or a user interface on the apparatus.

8. A method performed by a gateway connected to an automatic dialer, the method comprising:
detecting a first telephone phone number used for an active call;
detecting if a second telephone number is dialed;
determining if the second telephone number has a higher priority than the first telephone number by accessing a priority for the first telephone number and a priority for the second telephone number;
interrupting the active call and placing a new call using the second telephone number if the second telephone number has a higher priority than the first telephone number; and
ignoring the second telephone number and maintaining the active call if the second telephone number has a lower priority than the first telephone number.

9. The method of claim 8, wherein the step of determining further comprises comparing the priority of the second telephone number to the priority of the first telephone number.

10. The method of claim 9, wherein the priority of the first telephone number and the priority of the second telephone number are accessed from memory.

11. The method of claim 10, wherein the priority of the first telephone number and the priority of the second telephone number are placed into the memory by using one or more of a local computer interface, a remote computer interface, or a user interface for the gateway.

12. The method of claim 8, wherein the step of ignoring further comprises returning to the detecting step and awaiting a new second telephone number to be dialed.
